(19) United States
(12) Patent Application Publication
(10) Pub. No.: US 2013/0318918 A1
(43) Pub. Date: Dec. 5, 2013

(54) SYSTEM FOR PACKAGING HOMEMADE BABY FOOD

(71) Applicants: Dechelle Damien, Astoria, NY (US); Carlos Horruitiner, Astoria, NY (US)

(72) Inventors: Carlos Horruitiner, Astoria, NY (US); Dechelle Damien, Astoria, NY (US)

(21) Appl. No.: 13/909,441

(22) Filed: Jun. 4, 2013

Related U.S. Application Data
(60) Provisional application No. 61/655,627, filed on Jun. 5, 2012.

(51) Int. Cl. A61J 11/00

(52) U.S. Cl. CPC A61J 11/008
USPC 53/268

(57) ABSTRACT

A system for dispensing homemade baby food includes a dispenser with a nozzle and a plunger that can be moved toward the nozzle for dispensing baby food from the nozzle. The system further includes a container having a nipple that is releasably engageable with the nozzle so that baby food in the dispenser can be dispensed directly into the container. The container can be separated from the dispenser and sealed when a selected volume of the baby food has been placed in the container. The container with the baby food therein can be stored temporarily and used when needed.

### CROSS REFERENCE TO RELATED APPLICATION

This application claims priority on U.S. Provisional Patent Appl. No. 61/655,627 filed on Jun. 5, 2012, the entire disclosure of which is incorporated herein by reference.

### BACKGROUND OF THE INVENTION

1. Field of the Invention

The present disclosure relates generally to the field of food packaging and in particular to a system for packaging homemade baby food.

2. Description of the Related Art

At the age of four months, human infants begin eating solid foods. Many books and guides have been published containing timelines of when and how certain food and food groups should be introduced to infants. There is generally a period of several months between the time when solid foods are introduced to infants and when the child is capable of chewing solid foods. Thus, for a period of several months, solid foods are given to children in a pureed form.

Many companies sell baby food. Generally, baby food is sold in glass, plastic, or metal containers. Baby food is sold in both individual serving portions and several serving portions. Many of the most popular baby foods are massed produced and have preservatives to increase shelf life. A combination of preservatives, additives, and a general concern about the quality of mass produced goods has caused many parents to consider organic baby foods. However, organic foods usually are priced higher than mass produced goods. Thus, many parents have begun making their own baby food to combine the nutrition of organic baby foods with the cost savings of mass produced baby food.

The process of making baby food can be time consuming. Many parents make a large quantity of baby food in a large container and partition it into individual serving portions. The individual servings can be packaged in Tupperware containers, plastic bags or any other type of container. The individual servings can then be transported with the parents and baby and may be eaten “on the go.” However, there are several draw backs to the types of containers that currently are used to store and transport baby food. Tupperware and other plastic containers are bulky and take up space in a baby bag that already is full of diapers, formula, toys, and a host of other baby-related necessities. Plastic bags are disposable, but are also prone to tear or burst, especially when squeezed between other baby supplies in the baby bag. Moreover, both plastic bags and reusable plastic containers are inefficient and lead to waste. Some residual baby food is typically left in the large mixing container when the parent is spooning the food into the individual serving containers. Additional residue is left in the small containers during feeding. Hence, food is wasted and the exact portion a baby is eating cannot be ascertained. Thus, there is a need in the market for more efficient storage and transport of baby food.

Some baby food companies, such as Happytot Organic Superfoods, sell food in a collapsible pouch. The pouch has first and second surfaces, a gusset connecting the first and second surfaces at the bottom and a spout formed at a top seam of the first and second surfaces. The pouches are sold full of baby food. The spout is narrow and cannot be used to refill the pouch. Thus, it is an object of the present invention to provide a system for packaging homemade baby food.

It is a further object of the present invention to provide a system for packaging homemade baby food that is more efficient and leads to less waste.

### SUMMARY

The present disclosure relates to a system for packaging homemade baby food.

A system for packaging homemade baby food in accordance with the invention includes a dispenser, at least one container and at least one cap. The dispenser comprises a generally tubular barrel having opposite front and rear ends spaced apart along an axis of the barrel and having inner and outer peripheral surfaces extending between the ends. The front and rear ends of the barrel preferably are formed with removable attachment means, such as threads, bayonet attachments or the like.

The dispenser further comprises a rear wall assembly removably attached to the rear end of the barrel. For example, the rear wall assembly may include a rear plate and a rear collar that may be engaged threadedly with the rear end of the barrel. A central aperture may extend through the rear plate. The rear wall assembly may include a handgrip that may extend at an angle to the axis of the barrel.

The rear wall assembly may further include a piston mounted movably relative to the rear plate and the rear collar so that the piston can move along the axis of the barrel when the rear wall assembly is mounted to the barrel. The piston comprises a plunger and a shaft. The plunger has an outer periphery substantially corresponding to a cross-sectional shape defined by the interior of the barrel. The shaft preferably extends perpendicularly from the plunger and passes through the aperture in the rear plate. The rear wall assembly is configured to generate movement of shaft along the axis of the barrel when the rear wall assembly is mounted to the rear end of the barrel. For example, the shaft may include an array of ratchet teeth. In this embodiment, the rear wall assembly further includes a trigger mounted pivotably in proximity to the handgrip. The trigger preferably is configured so that movement of the trigger causes an incremental advancement of the shaft and the plunger of the piston along the axis of the barrel. The rear wall assembly of this embodiment further comprises a spring for biasing the trigger back to a starting position after each actuation and hence after each incremental movement of the piston and the plunger thereof. Other arrangements may be provided for axially advancing the plunger. For example, the shaft of the piston may be threadedly engaged in a threaded aperture in the rear plate. Thus, rotation of the shaft around the axis of the barrel will cause the piston to move axially along the barrel. In this embodiment, a crankshaft may extend angularly from the piston shaft to facilitate the generation of the required rotational forces of the shaft. Alternatively, a disk-shaped handle may be mounted to the rear end of the shaft to facilitate manual gripping for rotating the shaft about the axis of the barrel. In still other embodiments, a rack and pinion arrangement may be provided for generating axial movement of the shaft along the barrel. In all of these embodiments, the movement of the piston may be generated by manual or electrical power

The dispenser further includes a front wall assembly removably mounted to the front end of the barrel. The front wall assembly preferably includes a front plate and a front collar extending rearward from the front plate. The collar is configured for removable attachment with the front end of the barrel, such as by mating arrays of threads. The front plate is formed with a front aperture extending axially therethrough. A nozzle is formed on or mounted to the front plate at the front aperture. The nozzle preferably is formed with an array of threads, and most preferably an array of internal threads. A dispenser opening extends through the nozzle to provide communication with the interior of the barrel. A dispenser cap may be provided for selectively opening and closing the dispenser opening in the nozzle.

The container of the system for packaging homemade baby food preferably is collapsible and has an interior and a nipple that communicates with the interior. The nipple has threads that are engageable with the threads on the nozzle of the dispenser. The container also has a container cap for selectively closing the opening in the nipple.

The system for packaging homemade baby food preferably is used by preparing a batch of baby food, typically in a puree or flowable form. The dispenser then may be prepared by removing one of the front and rear wall assemblies from the barrel so that the interior of the barrel is accessible for filling the barrel with the homemade baby food. If the rear wall assembly of the dispenser is to be removed for filling the dispenser, then the dispenser cap is retained in position over the nozzle to prevent the baby food from escaping during the filling operation. The plunger then is moved to the rearward most position relative to the rear plate and the rear wall assembly is mounted back onto the rear end of the barrel. Alternatively, the plunger may be moved to the rearward most position while the rear wall assembly remains mounted to the barrel. The front wall assembly then may be removed from the barrel for filling the interior of the barrel with the baby food. As a further alternate, the front and rear wall assemblies may be retained on the barrel. The nozzle the may be immersed in the baby food and the piston is pulled rearward to create a low pressure in the barrel that draws the baby food into the barrel. The dispenser cap then may be placed over the nozzle while the containers are accessed.

Use of the system for packaging homemade baby food proceeds by removing the dispenser cap from the front wall assembly and threadedly engaging the nozzle of the dispenser with the nipple of the container. The container then is filled at least partly with baby food by actuating the trigger or other such actuator for causing the plunger to advance axially toward the front end of the barrel, thereby forcing the prepared baby food from the barrel, through the nozzle and into the container. The nozzle is unthreaded from the nipple when an appropriate volume of the baby food has been filled into the container. The container cap then is reattached to the nipple for closing the baby food within the container. Another container then may be filled in a similar manner. The barrel of the dispenser can be refilled merely by removing either the front or rear end wall assemblies to access the interior of the barrel. The piston then is retracted to the rear position and additional containers can be filled in the manner described above. The dispenser can be disassembled and cleaned when a sufficient number of containers have been filled.

### BRIEF DESCRIPTION OF THE DRAWINGS

FIG. 1 is an exploded side elevational view of the system for packaging homemade baby food in accordance with the invention.

FIG. 2 is a perspective view of the baby food dispenser of the system shown in FIG. 1.

FIG. 3 is side elevational view of a baby food dispenser shown in FIGS. 1 and 2.

FIG. 4 is a front elevational view of the container of FIG. 1 with the container cap partly attached.

### DETAILED DESCRIPTION OF THE PREFERRED EMBODIMENT

All examples and conditional language recited herein are intended for teaching purposes to aid the reader in understanding the principles of the disclosure and the concepts contributed by the inventor to furthering the art, and are to be construed as being without limitation to such specifically recited examples and conditions.

Moreover, all statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

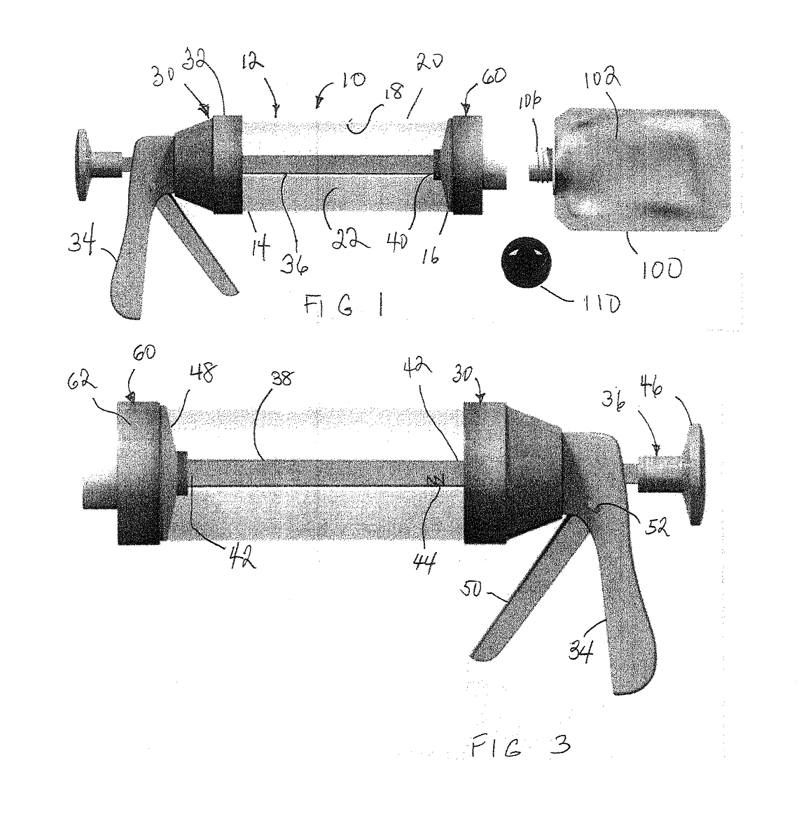

With reference to the drawings, embodiments of the present disclosure will be described. As shown in FIG. 1 a system for packaging homemade baby food in accordance with an embodiment of the invention includes a dispenser 10 and at least one container 100 and a container cap 110.

The dispenser 10 comprises a substantially tubular barrel 12 having opposite rear and front ends 14 and 16 spaced apart along an axial direction. The barrel 12 further has opposite inner and outer surfaces 18 and 20 extending between the rear and front ends 14 and 16. At least the inner surface 18 is of substantially uniform cross-sectional shape substantially from the rear end 14 to the front end 16. The inner surface 18 defines an interior 22 for the dispenser 10. At least the inner surface 18 of the barrel 12 preferably is substantially cylindrical. However, other shapes of uniform cross-section can be employed. The outer surface 20 of the barrel 12 preferably is formed with arrays of external threads adjacent the rear and front ends 14 and 16. The barrel 12 preferably is formed from a transparent material or has a transparent window extending at least partly along the barrel 12 between the rear and front ends 14 and 16. Additionally, the barrel 12 preferably is provided with volume marking indicia for measuring the total volume of baby food contained in the dispenser 10 and for measuring the volume of baby food that is being dispensed, as explained herein.

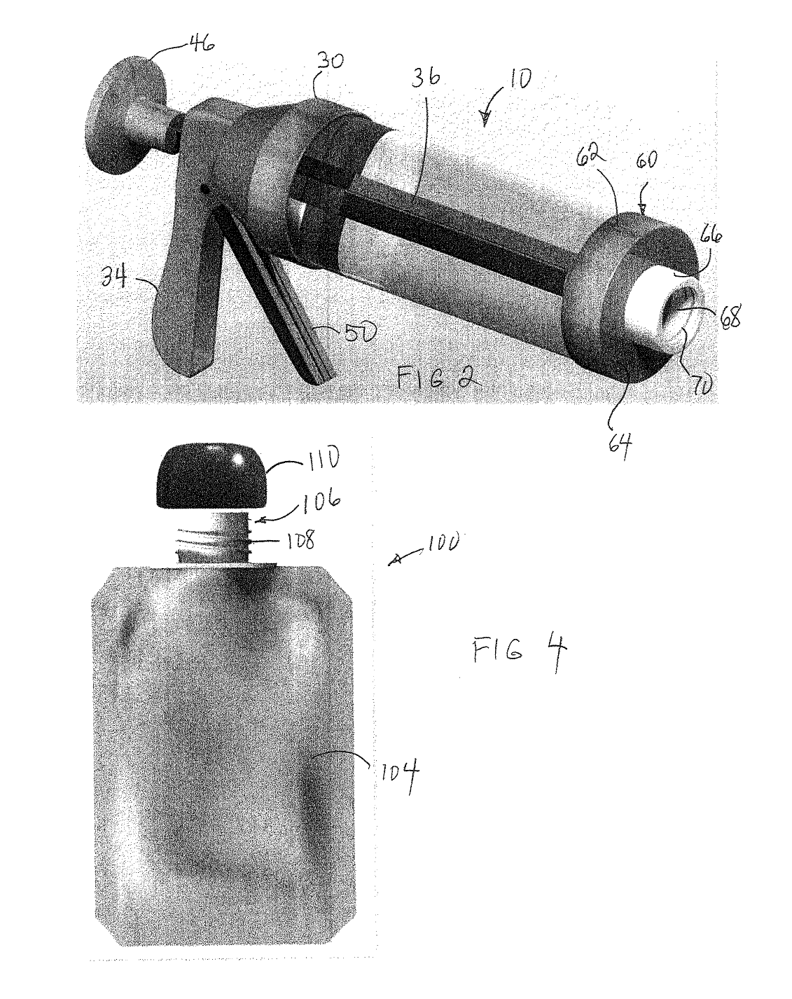

The dispenser 10 further includes a rear wall assembly 30 having an internally threaded rear collar 32 that is threadedly engaged with the threads at the rear end 14 of the barrel 12. A handgrip 34 projects from the rear wall assembly 30 at an angle to the axis of the barrel 12, and preferably substantially perpendicular to the axis of the barrel 12. The rear wall assembly 30 further includes a piston assembly 36. The piston assembly 36 includes a shaft 38 with opposite rear and front ends 40 and 42. Portions of the shaft 38 between the rear and front ends 40 and 42 extend through the handgrip 34 and the rear collar 32 and into the interior of the barrel 12 substantially along the axis of the barrel 12. One longitudinal side of the shaft 38 includes an array of ratchet teeth 44. A handle 46 is mounted to the rear end 40 of the shaft 38 to facilitate manipulation of the piston assembly 36, and in particular to facilitate rearward movement of the piston assembly 36 relative to the barrel 12. A plunger 48 is mounted to the front end 42 of the shaft 38. The plunger 48 has an outer periphery that conforms to the shape of the inner surface 18 of the barrel 12. Thus, in the preferred embodiment, the outer periphery of the plunger 48 is substantially circular and has a diameter corresponding to the diameter of the inner surface 18 of the barrel so that the plunger 48 is slidably movable along the inner surface 18 of the barrel 12. The rear wall assembly 30 further includes a trigger 50 that is pivotally mounted to the handgrip 34 at a pivot pin 52. The trigger 50 is spring biased into a forward position, as shown in FIGS. 1-3. However, the trigger 50 can be pivoted rearwardly toward the handgrip 34 and against the spring biased forces. This rearward pivoting movement of the trigger 50 causes an inner end of the trigger 50 to engage the ratchet teeth on the shaft 38, thereby moving the shaft 38 incrementally forward. The spring within the handgrip 34 will cause a return pivoting movement of the trigger 50 into the position shown in FIGS. 1-3, thereby placing the trigger 50 in a position to be actuated again.

The dispenser 10 further includes a front wall assembly 60. The front wall assembly 60 includes a front collar 62 threadedly engaged with the external threads at the front end 16 of the barrel 12. A front plate 64 extends across the front end of the front collar 62 and includes a central opening. A nozzle 66 is mounted to the front plate 64 at the opening and includes a passage 68 formed with an array of internal threads 70. The passage 68 communicates with the interior 22 of the barrel 12. A dispenser cap (not shown) can be provided for selectively closing the passage 68 through the front wall assembly 60.

The container 100 of the system for packaging homemade baby food includes opposite front and rear walls 102, 104 that are secured to one another about their peripheries. A nipple 106 is mounted between the front and rear walls 102, 104 at one end of the container and has an opening that communicates with the interior of the container 100. The nipple 106 further has an array of external threads 108 that are configured to engage the internal threads 70 on the nozzle 66. The container cap 110 includes an array of internal threads that match the internal threads 70 on the nozzle 66 so that the container cap 110 can be engaged threadedly with the external threads 108 on the nipple 106 to seal the contents of the container 100.

The system for packaging homemade baby food in accordance with the invention is used by initially preparing a batch of baby food. In one filling method, the piston assembly 36 is moved rearward relative to the rear wall assembly 30 and the front wall assembly 60 then is disengaged from the front end 16 of the barrel 12. The prepared baby food then may be spooned into the open front end 16 of the barrel 12. The front wall assembly 60 then is reattached to the front end 16 of the barrel 12. Any dispenser cap that may have been attached to the nozzle 66 is removed. An empty container 100 then is accessed and the container cap 110 then is removed from the nipple 106. The external threads 108 of the nipple 106 then our threadedly engaged with the internal threads 70 on the nipple 66 to provide a substantially fluid-tight connection between the dispenser 10 and the container 100. Baby food in the barrel 12 then is urged into the container 100 by repeatedly actuating the trigger 50 and thereby causing the plunger 48 to advance forwardly while sliding along the inner surface 18 of the barrel 12. This incremental forward movement of the plunger 48 will cause the baby food to be dispensed from the barrel 12 and directly into the interior of the container 100. The volume of baby food being dispensed into the container 100 can be determined precisely by the volume indicia provided on the side of the barrel 12. The container 100 can be threadedly disengaged from the nozzle 66 when a sufficient volume of baby food has been urged into the container 100. The container cap 110 then can be reengaged radically with the nipple 106 to seal the baby food within the container 100. Additional containers 100 can be filled in the same manner. More baby food can be loaded into the dispenser 10 when the initial volume has been exhausted. Additionally, the dispenser 10 can be disassembled and cleaned for storage or for use with a different type of baby food. In an alternate method, the front and rear wall assemblies 60 and 30 remain attached to the barrel. The piston assembly 36 is moved to the forward most position and the nozzle 66 is immersed in the baby food. The piston assembly then is pulled rearward, thereby drawing the baby food into the barrel 12. The containers 100 then are filled as described above.

Although the disclosure herein has been described with reference to particular illustrative embodiments, it is to be understood that these embodiments are merely illustrative of the principles and applications of the present disclosure. Therefore numerous modifications may be made to the illustrative embodiments and other arrangements may be devised without departing from the spirit and scope of the present disclosure.

The illustrated embodiment shows a trigger and ratchet arrangement for advancing the plunger within the dispenser. Other arrangements can be provided, however, for advancing the plunger within the dispenser. For example, the shaft 38 can be threaded and can be engaged threadedly with a mating array of internal threads on the rear wall assembly 30. The shaft 38 then can be advanced by rotating the handle 46 at the rear in 40 of the shaft. Alternatively, a rack and pinion arrangement can be provided. The shaft 38 can be formed with teeth that define the rack and the pinion can be mounted to the handgrip 34 for rotation about an axis perpendicular to the shaft. Additionally, an electric motor can be provided for advancing the shaft 38 within the barrel 12.

A cylindrical barrel 12 has been illustrated and is the preferred embodiment. However, the inner surface 18 of the barrel 12 can other shapes, provided that the plunger 48 conforms to the shape of inner surface 18 of the barrel 12.

The nozzle 66 can be unitary with the front wall assembly 60 or can be a separate part that is threadedly engaged with the front wall assembly 60. The nozzle 66 is illustrated as being internally threaded, but can be provided with an array of extra all threads for engaging internal threads on the nipple 106 of the container 100.

The containers 100 may be disposable or reusable.

What is claimed is:

1. A system for packaging baby food, comprising:
a dispenser with a barrel having opposite front and rear ends and an interior within the barrel between the front and rear ends, a nozzle at the front end of the barrel and having an opening to provide communication with the interior of the barrel, a plunger selectively movable between the front and rear ends of the barrel;
at least one container having an interior and a nipple providing communication between locations external of the container and the interior of the container, the nipple being configured for releasable fluid-tight connection with the nozzle of the dispenser; and
a cap releasably engageable with the nipple for sealing the interior of the container.

2. The system of claim 1, wherein the nozzle includes an array of internal threads and wherein the nipple includes an array of external threads that are releasably engageable with the internal threads of the nozzle.

3. The system of claim 2, wherein the dispenser includes a front wall assembly removably mounted to the barrel, the nozzle being provided on the front wall assembly.

4. The system of claim 3, wherein the nozzle is unitary with the front wall assembly.

5. The system of claim 3 wherein the nozzle is threadedly engaged with the front wall assembly.

6. The system of claim 1, wherein the dispenser includes a rear wall assembly removably attached to the rear end of the barrel.

7. The system of claim 6, wherein the rear wall assembly further includes an actuator for selectively moving the plunger toward the front end of the barrel.

8. The system of claim 1, wherein the at least one container comprises a plurality of containers.

9. A method for packaging homemade baby food, the method comprising:
providing a dispenser with a barrel having a threaded nozzle and a plunger selectively movable toward the nozzle;
placing a selected amount of baby food in the barrel;
providing a container with an interior and a threaded nipple communicating with the interior;
threadedly engaging the nipple of the container with the nozzle of the dispenser;
moving the plunger toward the nozzle for causing the baby food in the barrel to be dispensed through the nozzle, through the nipple and into the interior of the container;
unthreading the nipple from the nozzle; and
closing the container to seal the baby food in the interior of the container.

10. The method of claim 9, wherein the step of providing a container comprises providing a container with a container cap threadedly engaged with the nipple, the method further including removing the cap from the nipple prior to attaching the nipple to the nozzle, and wherein the step of closing the container comprises reattaching the cap to the nipple.

11. The method of claim 9, wherein the step of placing a selected amount of baby food in the barrel comprises moving the plunger toward the nozzle, immersing the nozzle in the baby food and moving the plunger away from the nozzle to draw the baby food through the nozzle and into the dispenser.
